(19) United States
(12) Patent Application Publication
(10) Pub. No.: US 2026/0292646 A1
(43) Pub. Date: Sep. 24, 2026

(54) SAPC RELEASE AND MAINTANENCE OF THE EXECUTED CONFIGURATION

(71) Applicant: Nokia Technologies Oy, Espoo (FI)

(72) Inventors: Xin ZHANG, Munich (DE); Umur KARABULUT, Munich (DE); Jani-Pekka KAINULAINEN, Cambridge (GB); Ahmad AWADA, Munich (DE)

(21) Appl. No.: 19/471,968

(22) PCT Filed: Feb. 2, 2024
(86) PCT No.: PCT/EP2024/052489

§ 371 Date: Oct. 2, 2025

Related U.S. Application Data
(60) Provisional application No. 63/494,508, filed on Apr. 6, 2023.

(51) Int. Cl. H04W 36/36

(52) U.S. Cl. CPC H04W 36/362

(57) ABSTRACT

A method, apparatus, and computer program product are provided. In the context of a method, the method receives by a user equipment from a master node, a reconfiguration message comprising a set of conditional primary cell of secondary cell group change configurations, wherein the set of conditional primary cell of secondary cell group change configurations comprise a set of execution conditions. The method evaluates the set of execution conditions. The method, based on the evaluation of the set of execution conditions, executes one of the set of conditional primary cell of secondary cell group change configurations. The method receives, from the master node, an indication that the executed conditional primary cell of secondary cell group change configuration to be retained. The method retains the executed conditional primary cell of secondary cell group change configuration.

### TECHNOLOGICAL FIELD

An example embodiment relates generally to techniques for selective activation of primary cells of secondary cell groups and, more particularly, to techniques for retaining a conditional primary cells of secondary cell group change configuration.

### BACKGROUND

User equipment often travels across wide geographical space. As user equipment moves, this can result in connection with a variety of primary cells of secondary cell groups that provide coverage. As user equipment switches primary cells of secondary cell groups, it receives a range of configurations associated with the primary cells of secondary cell groups. When one of these configurations is executed, user equipment will often retain the configuration of nearby primary cells of secondary cell groups (PSCell) in case of future primary cells of secondary cell group change. However, the user equipment does not necessarily keep the configuration that is executed. This can result in delay if the user equipment moves away from the primary cells of secondary cell groups and later moves back and has to re-receive the configuration again.

In new radio dual connectivity deployment scenarios with frequency range 2 based primary cells of secondary cell groups, user equipment is expected to have frequent mobility across primary cells of secondary cell groups. User equipment is also expected to have frequent mobility across primary cells of secondary cell groups for new radio dual connectivity deployments with secondary cell layers serving as capacity boosters with densely deployed secondary cells. Not retaining configurations increases PSCell change delay. RAN4 defines PSCell change delay: user equipment shall be capable to transmit physical random access channel preamble towards the new target PSCell no later than in slot n+T_{config_PSCell_Conditional}. Slot n is the last slot overlapping with the physical downlink shared channel containing conditional PSCell change. T_{config_PSCell_Conditional} is determined by the equation T_{config_PSCell_Conditional}=T_{RRC_delay}+T_{Event_DU}+Tₘₑₐₛᵤᵣₑ+T_{UE_preparation}+T_{processing}+T_{Δ}+T_{PSCell_DU}+2 ms. T_{RRC_delay} is the radio resource control processing delay, which is the corresponding radio resource control message embedded in an evolved universal terrestrial radio access radio resource control message. Otherwise, it is the radio resource control delay for processing the conditional PSCell addition command. This value starts counting from when a master node transmits a conditional (re)configuration containing the CPC configurations of the candidate target PSCell(s) to the user equipment. T_{Event_DU} is the delay uncertainty, or the time from when user equipment successfully decodes a conditional PSCell addition command until a condition exists at the measurement reference point which will trigger the conditional PSCell addition. Tₘₑₐₛᵤᵣₑ is determined as the measurements time delay defined from the end of T_{Event_DU} until user equipment executes a PSCell change to a target cell and interruption time starts. T_{UE_preparation} is defined as the user equipment preparation time for conditional PSCell addition, and starts after user equipment realizes the condition of PSCell addition is met and the identity of the PSCell is determined. This time period can be up to 10 ms. T_{processing} is defined as the SW processing time needed by user equipment, including the radio frequency warmup period. This time period is 20 ms when the PSCell is in frequency range 1, and it is 40 ms when PSCell is in frequency range 2. T_{Δ} is defined as time for fine time tracking and acquiring full timing information of the target cell. This is equal to 1*Trs ms. T_{PSCell_DU} is defined as the delay uncertainty in acquiring the first available physical random access channel occasion in the PSCell. This time can be up to the summation of synchronization signal block to physical random access channel occasion association period and 10 ms. Trs is defined as the SMTC periodicity of the target cell if the user equipment has been provided with an SMTC configuration for the target cell in a PSCell addition message. Otherwise, Trs is the SMTC configured in the measObjectNR having the same SSB frequency and subcarrier spacing. If the user equipment is not provided with an SMTC configuration or measurement object on this frequency, the requirement in this clause is applied with Trs as equal to 5 ms, assuming the synchronization signal block transmission periodicity is 5 ms. If the synchronization signal block transmission periodicity is not 5 ms, there is no requirement.

The following procedure is used to support subsequent secondary cell group change. When the execution condition of a conditional PSCell change candidate PSCell is met, user equipment performs the execution of conditional PSCell change towards the candidate PSCell. After finishing the PSCell addition or change, the user equipment retains the conditional configuration of other candidate PSCells for subsequent conditional PSCell change. The user equipment continues to evaluate the execution conditions of other candidate PSCells. When the execution condition of another candidate PSCell is met, the user equipment performs the execution of the conditional PSCell change towards the other candidate PSCell. Currently, it is assumed that if user equipment needed to be able to return to a current secondary cell group by conditional procedure, the network could explicitly configure a candidate configuration for that cell. In secondary cell selective activation, the conditional PSCell change or conditional PSCell addition configurations for the user equipment are released after PCell change for inter master node changes by explicit indication from the network. R2 assumes that a conditional PSCell addition configuration can be used for conditional PSCell change with different triggering conditions. It is not clear that the conditional PSCell change configuration is retained by the user equipment after the user equipment executes the configuration.

### BRIEF SUMMARY

A method, apparatus, and computer program product are disclosed for retaining of executed conditional primary cell of secondary cell group change configurations. Embodiments described herein allow user equipment and a network to retain a configuration corresponding to an executed condition.

In an example embodiment, a method is provided that includes receiving by a user equipment from a master node, a reconfiguration message including a set of conditional primary cell of secondary cell group change configurations, wherein the set of conditional primary cell of secondary cell group change configurations include a set of execution conditions. The method further includes evaluating the set of execution conditions. The method further includes, based on the evaluation of the set of execution conditions, executing one of the set of conditional primary cell of secondary cell group change configurations. The method further includes receiving an indication that the executed conditional primary cell of secondary cell group change configuration. The method further includes retaining the executed conditional primary cell of secondary cell group change configuration.

In an example embodiment, the reconfiguration message includes the indication that the executed conditional primary cell of secondary cell group change configuration to be retained.

In an example embodiment, the indication that the executed conditional primary cell of secondary cell group change configuration to be retained is received from a target secondary node in a second reconfiguration message after execution.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

The method of an example embodiment further includes completing a random access procedure associated with the executed conditional primary cell of secondary cell change configuration.

In an example embodiment, the indication that the executed conditional primary cell of secondary cell group change configuration to be retained includes an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained.

In an example embodiment, the reconfiguration message includes the indication that the one or more of the set of conditional primary cell of secondary cell group change configuration not to be retained.

In an example embodiment, the indication that the one or more of the set of conditional primary cell of secondary cell group change configuration not to be retained is received in a second reconfiguration message after execution.

In an example embodiment, a method is provided that includes receiving by a target secondary node, a secondary node addition request from a source master node. The method further includes determining a set of primary cells of secondary cell associated with a set of conditional primary cell of secondary cell group change configurations. The method further includes transmitting an indication that an executed conditional primary cell of secondary cell group change configuration of the set of conditional primary cell of secondary cell group change configurations to be retained. The method further includes transmitting the set of conditional primary cell of secondary cell group change to the source master node.

In an example embodiment, the indication that the executed conditional primary cell of secondary cell group change configuration to be retained is transmitted to a source master node prior to the execution of the executed conditional primary cell of secondary cell group change configuration.

In an example embodiment, the indication is transmitted by the source master node to a user equipment.

In an example embodiment, the indication that the executed conditional primary cell of secondary cell group change configuration to be retained is transmitted to a user equipment after executing the executed conditional primary cell of secondary cell group change configuration and during a connected period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

In an example embodiment, a method is provided that includes receiving by a user equipment from a master node, a reconfiguration message including a set of conditional primary cell of secondary cell group change configurations, wherein the set of conditional primary cell of secondary cell group change configurations include a set of execution conditions. The method further includes evaluating the set of execution conditions. The method further includes, based on the evaluation of the set of execution conditions, executing one of the set of conditional primary cell of secondary cell group change configurations. The method further includes transmitting to another target secondary node, an indication that the executed conditional primary cell of secondary cell group change configuration to be retained. The method further includes retaining the executed conditional primary cell of secondary cell group change configuration.

In an example embodiment, the indication that the executed conditional primary cell of secondary cell group change configuration to be retained is transmitted after execution during a connection period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes an uplink control information message.

The method of an example embodiment further includes completing a random access procedure associated with the executed conditional primary cell of secondary cell group change configuration.

In an example embodiment, a non-transitory computer readable storage medium is provided including computer instructions that, when executed by an apparatus, cause the apparatus at least to receive by a user equipment from a master node, a reconfiguration message including a set of conditional primary cell of secondary cell group change configurations, wherein the set of conditional primary cell of secondary cell group change configurations include a set of execution conditions. The non-transitory computer readable storage medium further includes computer instructions configured, upon execution, to evaluate the set of execution conditions. The non-transitory computer readable storage medium further includes computer instructions configured, upon execution, to, based on the evaluation of the set of execution conditions, execute one of the set of conditional primary cell of secondary cell group change configurations. The non-transitory computer readable storage medium further includes computer instructions configured, upon execution, to receive an indication that the executed conditional primary cell of secondary cell group change configuration The non-transitory computer readable storage medium further includes computer instructions configured, upon execution, to retain the executed conditional primary cell of secondary cell group change configuration.

In an example embodiment, the reconfiguration message includes the indication that the executed conditional primary cell of secondary cell group change configuration to be retained.

In an example embodiment, the indication that the executed conditional primary cell of secondary cell group change configuration to be retained is received from a target secondary node in a second reconfiguration message after execution.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

In an example embodiment, the non-transitory computer readable storage medium further includes computer instructions configured, upon execution, to complete a random access procedure associated with the executed conditional primary cell of secondary cell change configuration.

In an example embodiment, the indication that the executed conditional primary cell of secondary cell group change configuration to be retained includes an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained.

In an example embodiment, the reconfiguration message includes the indication that the one or more of the set of conditional primary cell of secondary cell group change configuration not to be retained.

In an example embodiment, the indication that the one or more of the set of conditional primary cell of secondary cell group change configuration not to be retained is received in a second reconfiguration message after execution.

In an example embodiment, a non-transitory computer readable storage medium is provided including computer instructions that, when executed by an apparatus, cause the apparatus to receive by a target secondary node, a secondary node addition request from a source master node. The non-transitory computer readable storage medium further includes computer instructions configured, upon execution, to determine a set of primary cells of secondary cell associated with a set of conditional primary cell of secondary cell group change configurations. The non-transitory computer readable storage medium further includes computer instructions configured, upon execution, to transmit an indication that an executed conditional primary cell of secondary cell group change configuration of the set of conditional primary cell of secondary cell group change configurations to be retained. The non-transitory computer readable storage medium further includes computer instructions configured, upon execution, to transmit the set of conditional primary cell of secondary cell group change to the source master node.

In an example embodiment, the indication that the executed conditional primary cell of secondary cell group change configuration to be retained is transmitted to a source master node prior to the execution of the executed conditional primary cell of secondary cell group change configuration.

In an example embodiment, the indication is transmitted by the source master node to a user equipment.

In an example embodiment, the indication that the executed conditional primary cell of secondary cell group change configuration to be retained is transmitted to a user equipment after executing the executed conditional primary cell of secondary cell group change configuration and during a connected period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

In an example embodiment, a non-transitory computer readable storage medium is provided including computer instructions that, when executed by an apparatus, cause the apparatus at least to receive by a user equipment from a master node, a reconfiguration message including a set of conditional primary cell of secondary cell group change configurations, wherein the set of conditional primary cell of secondary cell group change configurations include a set of execution conditions. The non-transitory computer readable storage medium further includes computer instructions configured, upon execution, to evaluate the set of execution conditions. The non-transitory computer readable storage medium further includes computer instructions configured, upon execution, to, based on the evaluation of the set of execution conditions, execute one of the set of conditional primary cell of secondary cell group change configurations. The non-transitory computer readable storage medium further includes computer instructions configured, upon execution, to transmit to another target secondary node, an indication that the executed conditional primary cell of secondary cell group change configuration to be retained. The non-transitory computer readable storage medium further includes computer instructions configured, upon execution, to retain the executed conditional primary cell of secondary cell group change configuration.

In an example embodiment, the indication that the executed conditional primary cell of secondary cell group change configuration to be retained is transmitted after execution during a connection period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes an uplink control information message.

In an example embodiment, the non-transitory computer readable storage medium further includes computer instructions configured, upon execution, to complete a random access procedure associated with the executed conditional primary cell of secondary cell group change configuration.

In an example embodiment, a user equipment is provided that includes at least one processor and at least one memory including computer program code with the at least one memory and the computer program code configured to, with the at least one processor, cause the user equipment to receive from a master node, a reconfiguration message including a set of conditional primary cell of secondary cell group change configurations, wherein the set of conditional primary cell of secondary cell group change configurations include a set of execution conditions. The at least one memory and the computer program code are further configured to, with the at least one processor, cause the user equipment to evaluate the set of execution conditions. The at least one memory and the computer program code are further configured to, with the at least one processor, cause the user equipment to, based on the evaluation of the set of execution conditions, execute one of the set of conditional primary cell of secondary cell group change configurations. The at least one memory and the computer program code are further configured to, with the at least one processor, cause the user equipment to receive an indication that the executed conditional primary cell of secondary cell group change configuration. The at least one memory and the computer program code are further configured to, with the at least one processor, cause the user equipment to retain the executed conditional primary cell of secondary cell group change configuration.

In an example embodiment, the reconfiguration message includes the indication that the executed conditional primary cell of secondary cell group change configuration to be retained.

In an example embodiment, the indication that the executed conditional primary cell of secondary cell group change configuration to be retained is received from a target secondary node in a second reconfiguration message after execution.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication comprises a downlink control information message.

In an example embodiment, the at least one memory and the computer program code are further configured to, with the at least one processor, cause the user equipment to complete a random access procedure associated with the executed conditional primary cell of secondary cell change configuration.

In an example embodiment, the indication that the executed conditional primary cell of secondary cell group change configuration to be retained includes an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained.

In an example embodiment, the reconfiguration message includes the indication that the one or more of the set of conditional primary cell of secondary cell group change configuration not to be retained.

In an example embodiment, the indication that the one or more of the set of conditional primary cell of secondary cell group change configuration not to be retained is received in a second reconfiguration message after execution.

In an example embodiment, a target secondary node is provided that includes at least one processor and at least one memory including computer program code with the at least one memory and the computer program code configured to, with the at least one processor, cause the target secondary node to receive a secondary node addition request from a source master node. The at least one memory and the computer program code are further configured to, with the at least one processor, cause the secondary node to determine a set of primary cells of secondary cell groups associated with a set of conditional primary cell of secondary cell group change configurations. The at least one memory and the computer program code are further configured to, with the at least one processor, cause the secondary node to transmit an indication that an executed conditional primary cell of secondary cell group change configuration of the set of conditional primary cell of secondary cell group change configurations to be retained. The at least one memory and the computer program code are further configured to, with the at least one processor, cause the secondary node to transmit the set of conditional primary cell of secondary cell group change configurations to the source master node.

In an example embodiment, the indication that the executed conditional primary cell of secondary cell group change configuration to be retained is transmitted to a source master node prior to the execution of the executed conditional primary cell of secondary cell group change configuration.

In an example embodiment, the indication is transmitted by the source master node to a user equipment.

In an example embodiment, the indication that the executed conditional primary cell of secondary cell group change configuration to be retained is transmitted to a user equipment after executing the executed conditional primary cell of secondary cell group change configuration and during a connected period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

In an example embodiment, a user equipment is provided that includes at least one processor and at least one memory including computer program code with the at least one memory and the computer program code configured to, with the at least one processor, cause the user equipment at least to receive from a master node, a reconfiguration message including a set of conditional primary cell of secondary cell group change configurations, wherein the set of conditional primary cell of secondary cell group change configurations include a set of execution conditions. The at least one memory and the computer program code are further configured to, with the at least one processor, cause the user equipment to evaluate the set of execution conditions. The at least one memory and the computer program code are further configured to, with the at least one processor, cause the user equipment to, based on the evaluation of the set of execution conditions, execute one of the set of conditional primary cell of secondary cell group change configurations. The at least one memory and the computer program code are further configured to, with the at least one processor, cause the user equipment to transmit to another target secondary node, an indication that the executed conditional primary cell of secondary cell group change configuration to be retained. The at least one memory and the computer program code are further configured to, with the at least one processor, cause the user equipment to retain the executed conditional primary cell of secondary cell group change configuration.

In an example embodiment, the indication that the executed conditional primary cell of secondary cell group change configuration to be retained is transmitted after execution during a connection period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes an uplink control information message.

In an example embodiment, the at least one memory and the computer program code are further configured to, with the at least one processor, cause the user equipment to complete a random access procedure associated with the executed conditional primary cell of secondary cell group change configuration.

In an example embodiment, a user equipment is provided including means for receiving from a master node, a reconfiguration message including a set of conditional primary cell of secondary cell group change configurations, wherein the set of conditional primary cell of secondary cell group change configurations include a set of execution conditions. The user equipment further includes means for evaluating the set of execution conditions. The user equipment further includes means for, based on the evaluation of the set of execution conditions, executing one of the set of conditional primary cell of secondary cell group change configurations. The user equipment further includes means for receiving an indication that the executed conditional primary cell of secondary cell group change configuration to be retained. The user equipment further includes means for retaining the executed conditional primary cell of secondary cell group change configuration.

In an example embodiment, the reconfiguration message includes the indication that the executed conditional primary cell of secondary cell group change configuration to be retained.

In an example embodiment, the indication that the executed conditional primary cell of secondary cell group change configuration to be retained is received from a target secondary node in a second reconfiguration message after execution.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

The user equipment of an example embodiment further includes means for completing a random access procedure associated with the executed conditional primary cell of secondary cell change configuration.

In an example embodiment, that the executed conditional primary cell of secondary cell group change configuration to be retained includes an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained.

In an example embodiment, the reconfiguration message includes the indication that the one or more of the set of conditional primary cell of secondary cell group change configuration not to be retained.

In an example embodiment, the indication that the one or more of the set of conditional primary cell of secondary cell group change configuration not to be retained is received in a second reconfiguration message after execution.

In an example embodiment, a target secondary node is provided including: means for receiving a secondary node addition request from a source master node. The target secondary node further includes means for determining a set of primary cells of secondary cell groups associated with a set of conditional primary cell of secondary cell group change configurations. The secondary node further includes means for transmitting an indication that an executed conditional primary cell of secondary cell group change configuration of the set of conditional primary cell of secondary cell group change configurations to be retained. The secondary node further includes means for transmitting the set of conditional primary cell of secondary cell group change configurations to the source master node.

In an example embodiment, the indication that the executed conditional primary cell of secondary cell group change configuration to be retained is transmitted to a source master node prior to the execution of the executed conditional primary cell of secondary cell group change configuration.

In an example embodiment, the indication is transmitted by the source master node to a user equipment.

In an example embodiment, the indication that the executed conditional primary cell of secondary cell group change configuration to be retained is transmitted to a user equipment after executing the executed conditional primary cell of secondary cell group change configuration and during a connected period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes a downlink control information message.

In an example embodiment, a user equipment is provided including means for receiving from a master node, a reconfiguration message including a set of conditional primary cell of secondary cell group change configurations, wherein the set of conditional primary cell of secondary cell group change configurations include a set of execution conditions. The user equipment further includes means for evaluating the set of execution conditions. The user equipment further includes means for, based on the evaluation of the set of execution conditions, executing one of the set of conditional primary cell of secondary cell group change configurations. The user equipment further includes means for transmitting to another target secondary node, an indication that the executed conditional primary cell of secondary cell group change configuration to be retained. The user equipment further includes means for retaining the executed conditional primary cell of secondary cell group change configuration.

In an example embodiment, the indication that the executed conditional primary cell of secondary cell group change configuration to be retained is transmitted after execution during a connection period.

In an example embodiment, the set of conditional primary cell of secondary cell group change configurations includes a plurality of conditional primary cell of secondary cell group change configurations.

In an example embodiment, the indication includes a radio resource control message.

In an example embodiment, the indication includes a MAC control element message.

In an example embodiment, the indication includes an uplink control information message.

The user equipment of an example embodiment further includes means for completing a random access procedure associated with the executed conditional primary cell of secondary cell group change configuration.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 is a block diagram of a system including both a base station and user equipment configured to communicate via at least uplink and downlink transmission in accordance with an example embodiment of the present disclosure;

FIG. 2 is a block diagram of an example communication system in which the system of FIG. 1 may be deployed in accordance with an example embodiment of the present disclosure;

FIG. 3 is a flow diagram demonstrating source node initiated inter-source node conditional primary cells of secondary cell group change in accordance with previous embodiments;

FIG. 4 is an illustration depicting a primary cell of secondary cell group change when user equipment is configured with CPAC selective activation in accordance with previous embodiments;

FIG. 5 is an illustration of a problem with conditional primary cells of secondary cell group change in accordance with previous embodiments;

FIG. 6 is a flow diagram demonstrating an example where the user equipment receives an indication to retain an executed conditional primary cell of secondary cell group change configuration prior to execution in accordance with an example embodiment of the present disclosure;

FIG. 7 is a flow diagram demonstrating an example where the user equipment receives an indication to retain an executed conditional primary cell of secondary cell group change configuration after execution in accordance with an example embodiment of the present disclosure;

FIG. 8 is a flow diagram demonstrating an example where the user equipment causes transmission of an indication to retain an executed conditional primary cell of secondary cell group change configuration after execution in accordance with an example embodiment of the present disclosure;

FIG. 9 is a flowchart demonstrating the operations performed, such as by the apparatus of FIG. 2, in order to retain an executed conditional primary cell of secondary cell group change configuration in accordance with an example embodiment of the present disclosure;

FIG. 10 is a flowchart demonstrating the operations performed, such as by the apparatus of FIG. 2, in order to transmit of a set of conditional primary cell of secondary cell group change configurations in accordance with an example embodiment of the present disclosure;

FIG. 11 is a flowchart demonstrating alternate operations performed, such as by the apparatus of FIG. 2, in order to retain an executed conditional primary cell of secondary cell group change configuration in accordance with an example embodiment of the present disclosure;

### DETAILED DESCRIPTION

Some embodiments of the present disclosure will now be described more fully hereinafter with reference to the accompanying drawings, in which some, but not all, embodiments are shown. Indeed, various embodiments may be embodied in many different forms and not to be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present disclosure. Thus, use of any such terms not to be taken to limit the spirit and scope of embodiments of the present disclosure.

Additionally, as used herein, the term “circuitry” refers to (a) hardware-only circuit implementations (e.g., implementations in analog circuitry and/or digital circuitry); (b) combinations of circuits and computer program product(s) including software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of “circuitry” applies to all uses of this term herein, including in any claims. As a further example, as used herein, the term “circuitry” also includes an implementation including one or more processors and/or portion(s) thereof and accompanying software and/or firmware. As another example, the term “circuitry” as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

As used herein, the term “computer-readable medium” refers to non-transitory storage hardware, non-transitory storage device or non-transitory computer system memory that may be accessed by a controller, a microcontroller, a computational system or a module of a computational system to encored thereon computer-executable instructions or software programs. A non-transitory “computer readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more universal synchronous bus (USB) flash drives), computer system memory or random-access memory (such as dynamic random access memory (DRAM), static random access memory (SRAM), extended data out random access memory (EDO RAM), and the like.

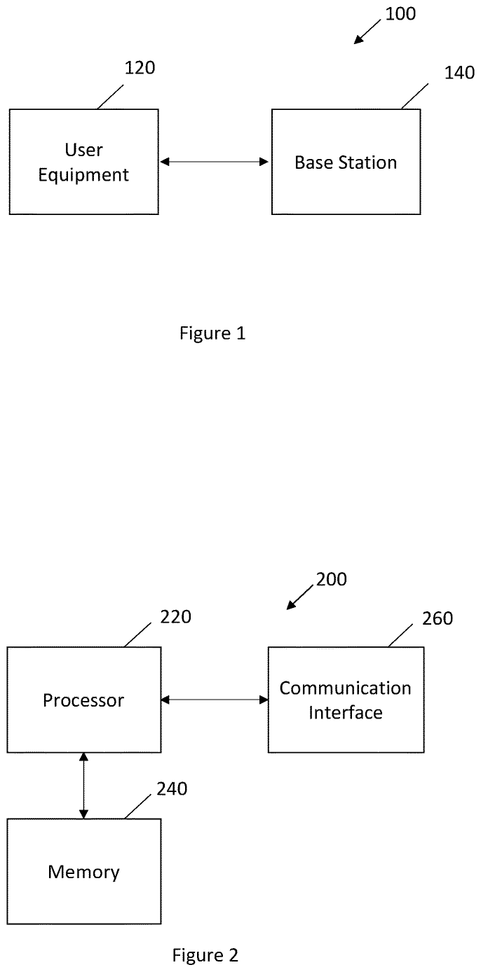

As illustrated in FIG. 1, a system 100 is provided in accordance with an example embodiment in order to facilitate uplink transmission from user equipment 120. Although the system may be configured in various manners, the system of one embodiment is depicted in FIG. 1 and includes both user equipment 120 and base station 140 configured to communicate via uplink and downlink transmission and reception beams. Although one user equipment and one base station is depicted, the system may include and the user equipment 120 and/or base station 140 may communicate with additional user equipment and base stations in other embodiments. In one or more embodiments, the user equipment 120 and base station 140 may configured to support, for example, 5G, 5G advanced, or 6G. In one or more embodiments, the system 100 may support carrier aggregation and/or dual connectivity. As described below, the system is configured to transmit messages and reports, such as reconfiguration messages, radio resource control messages, MAC control element messages, downlink control information messages, and/or the like.

The data that is transmitted via the uplink and downlink beams between the user equipment 120 and the base station 140 can be any of a wide variety of data including, but not limited to digital imagery data including video data, audio data as well as data provided by sensors, radars, telescopes and radio receivers. In at least some instances, the data is encoded prior to communication of the data via the uplink and downlink beams and decoded upon reception. The resulting data received may be utilized for a variety of purposes including presentation to a user, storage of the data for subsequent use and/or provision of the data to one or more applications, such as applications that perform statistical inference on the data for various purposes including object recognition, image classification, spectrum sensing, speech transcription and/or prediction or detection of events.

The user equipment 120 of FIG. 1 (also called UE, user device, user terminal, terminal device, etc.) illustrated one type of an apparatus which resources on an air interface are allocated and assigned. The user equipment 120 typically refers to a portable computing device that includes wireless mobile communication devices operating with or without a subscriber identification module (SIM), including, but not limited to, the following types of devices: a mobile station (mobile phone), smartphone, personal digital assistance (PDA), handset, device using a wireless modem (alarm or measurement device, etc.), laptop and/or touch screen computer, tablet, game console, notebook, and multimedia device. User equipment 120 may also be a device having capability to operate in Internet of Things (IoT) network which is a scenario in which objects are provided with the ability to transfer data over a network without requiring human-to-human or human-to-computer interaction. The user equipment 120 (or in some embodiments a layer 3 relay node) is configured to perform one or more of user equipment functionalities. The user equipment 120 may also be called a subscriber unit, mobile station, remote terminal, access terminal, user terminal, or user equipment (UE) just to mention but a few names or apparatuses.

The base station 140 of FIG. 1 may include, for example, remote radio heads (RRHs), transmission reception points (TRPs), access points, node Bs (e.g., gNB) or other transmission sources. The base station 140 may be configured to communicate with user equipment 120 via a network.

The base station 140 may operate as part of a cell group. Base station 140 may be part of a master cell group (MCG) or a secondary cell group (SCG). In one or more embodiments, base station 140 may operate as a primary cell in the MCG or SCG. In one or more embodiments, base station 140 may operate as a secondary cell in the MCG or SCG. In one or more alternate embodiments, user equipment 120 may move locations, necessitating a new MCG or SCG. In one or more embodiments, user equipment 120 may utilize selective activation of SCG or selective activation of MCG. In one or more embodiments, user equipment 120 moving cells may result in the previous source PSCell changing to a target PSCell with conditional PSCell change. In one or more embodiments, PSCell addition/change configurations configured for selective activation are retained at the user equipment side and the network side.

FIG. 2 depicts an example apparatus 200 that may be configured to function as user equipment 120 or base station 140. As shown in FIG. 2, the apparatus includes, is associated with, or is in communications with processing circuitry 220, a memory 240, and a communication interface 260. The processing circuitry 220 may be in communication with the memory device 240 via a bus for passing information among components of the apparatus. The memory device may be non-transitory and may include, for example, one or more volatile and/or non-volatile memories. In other words, for example, the memory device may be an electronic storage device (e.g., a computer readable storage medium) including gates configured to store data (e.g., bits) that may be retrievable by a machine (e.g., a computing device like the processing circuitry). The memory device may be configured to store information, data, content, applications, instructions, or the like for enabling the apparatus to carry out various functions in accordance with an example embodiment of the present disclosure. For example, the memory device could be configured to buffer input data for processing by the processing circuitry. Additionally or alternatively, the memory device could be configured to store instructions for execution by the processing circuitry.

The apparatus 200 may, in some embodiments, be embodied in various computing devices described as above. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment on a single chip or as a single “system on a chip.” As such, in some cases, a chip or chipset may constitute means for performing one or more operations for providing the functionalities described herein.

The processing circuitry 220, also referenced as a processor, may be embodied in a number of different ways. For example, the processing circuitry may be embodied as one or more of various hardware processing means such as a coprocessor, a microprocessor, a controller, a digital signal processor (DSP), a processing element with or without an accompanying DSP, or various other circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processing circuitry may include one or more processing cores configured to perform independently. A multi-core processing circuitry may enable multiprocessing within a single physical package. Additionally or alternatively, the processing circuitry may include one or more processors configured in tandem via the bus to enable independent execution of instructions, pipelining, and/or multithreading.

In an example embodiment, the processing circuitry 220 may be configured to execute instructions stored in the memory device 240 or otherwise accessible to the processing circuitry. Alternatively or additionally, the processing circuitry may be configured to execute hardcoded functionality. As such, whether configured by hardware or software methods, or by a combination thereof, the processing circuitry may represent an entity (e.g., physically embodied in circuitry) capable of performing operations according to an embodiment of the present disclosure while configured accordingly. Thus, for example, when the processing circuitry is embodied as an ASIC, FPGA or the like, the processing circuitry may be specifically configured hardware for conducting the operations described herein. Alternatively, as another example, when the processing circuitry is embodied as an executor of instructions, the instructions may specifically configure the processor to perform the algorithms and/or operations described herein when the instructions are executed. However, in some cases, the processing circuitry may be a processor of a specific device (e.g., an image or video processing system) configured to employ an embodiment by further configuration of the processing circuitry by instructions for performing the algorithms and/or operations described herein. The processing circuitry may include, among other things, a clock, an arithmetic logic unit (ALU) and logic gates configured to support operation of the processing circuitry.

The communication interface 260 may be any means such as a device or circuitry embodied in either hardware or a combination of hardware and software that is configured to receive and/or transmit data including media content in the form of video or image files, one or more audio tracks or the like. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communications interface may alternatively or also support wired communication. As such, for example, the communication interface may include a communication modem and/or other hardware/software for supporting communication via cable, digital subscriber line (DSL), universal serial bus (USB) or other mechanisms.

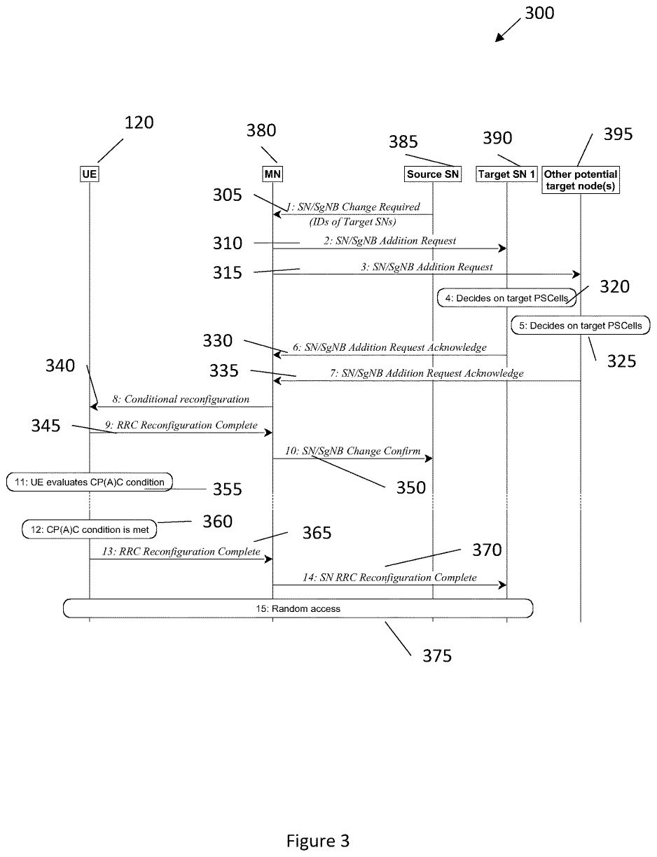

Turning now to FIG. 3, a signaling diagram illustrates a process 300 for source node initiated inter-source node conditional PSCell change (CPC) according to previous methods. In this example embodiment, the user equipment 120 is connected to a source master node 380 and a source secondary node 385 and uses selective activation to change to a target secondary node 390 among other potential target secondary nodes 395.

In one or more embodiments, at operation 305, the source secondary node 385 indicates to the master node that there is a source secondary node change required. In one or more embodiments, the source secondary node 385 transmits to the master node a list of IDs of target secondary nodes that will be contacted for preparing target PSCell(s). In one or more embodiments, the source secondary node suggests a list of PSCells to be prepared by the target secondary nodes. In one or more embodiments, the source secondary node provides a CPC execution condition for each suggested target PCell.

In one or more embodiments, at operation 310, the master node 380 transmits an addition request to target secondary node 390. In one or more embodiments, master node 380 transmits the secondary node addition request to target secondary node 390 in response to target secondary node 390 being included in the list of target secondary nodes transmitted in operation 305.

In one or more embodiments, at operation 315, the master node 380 transmits addition requests to other target secondary nodes 395. In one or more embodiments, master node 380 transmits the secondary node addition request to other target secondary nodes 395 in response to target secondary node 395 being included in the list of target secondary nodes transmitted in operation 305.

In one or more embodiments, at operation 320, the target secondary node 390 decides on the candidate target PSCell(s) to prepare from among the list of PSCells that were suggested by source secondary node 385 to be prepared.

In one or more embodiments, at operation 325, the other target secondary nodes 395 decide on the candidate target PSCell(s) to prepare from among the list of PSCells that were suggested by source secondary node 385 to be prepared.

In one or more embodiments, at operation 330, the target secondary node 390 transmits the CPC configuration for each prepared target PSCell to the master node 380. In one or more embodiments, at operation 330, the target secondary node 390 transmits the ID of each prepared target PSCell to the master node 380.

In one or more embodiments, at operation 335, the other target secondary nodes 395 transmit the CPC configuration for each prepared target PSCell to the master node 380. In one or more embodiments, at operation 335, the other target secondary nodes 395 transmit the ID of each prepared target PSCell to the master node 380.

In one or more embodiments, at operation 340, the master node 380 transmits a conditional (re)configuration containing the CPC configurations of the candidate target PSCell(s) to the user equipment 120. In one or more embodiments, at operation 340, the master node 380 transmits CPC execution conditions corresponding to the transmitted CPC configurations of the candidate target PSCell(s) to the user equipment 120.

In one or more embodiments, at operation 345, the user equipment transmits a confirmation to the master node 380 that the user equipment 120 received the conditional (re)configuration.

In one or more embodiments, at operation 350, the master node 380 transmits a confirmation to source secondary node 385 that user equipment 120 received the (re)configuration. In one or more embodiments, the master node 380 confirms secondary node change preparation to source secondary node 385.

In one or more embodiments, at operation 355, user equipment 120 evaluates the CPC execution conditions corresponding to the transmitted CPC configurations of the candidate target PSCell(s). In one or more embodiments, at operation 355, user equipment 120 evaluates the CPC execution conditions of the prepared target PSCell(s).

In one or more embodiments, at operation 360, a CPC execution condition is met for a candidate target PSCell. In one or more embodiments, at operation 360, a CPC execution condition is met for a candidate target PSCell in target secondary node 390. In one or more embodiments, the CPC execution condition includes a CP(A)C execution condition. In one or more embodiments, the CPC configuration is executed.

In one or more embodiments, at operation 365, user equipment 120 transmits a message to master node 380 indicating the execution of the CPC configuration. In one or more embodiments, the message includes an embedded secondary node radio resource control reconfiguration complete to the target source node corresponding to the executed CPC configuration. In one or more embodiments, the radio resource control reconfiguration complete is to target source node 390.

In one or more embodiments, at operation 370, the master node 380 transmits the secondary node radio resource control reconfiguration complete to the target source node corresponding to the executed CPC configuration. In one or more embodiments, the radio resource control reconfiguration complete is to target source node 390.

In one or more embodiments, at operation 375, user equipment 320 completes a random access procedure for target source node 390.

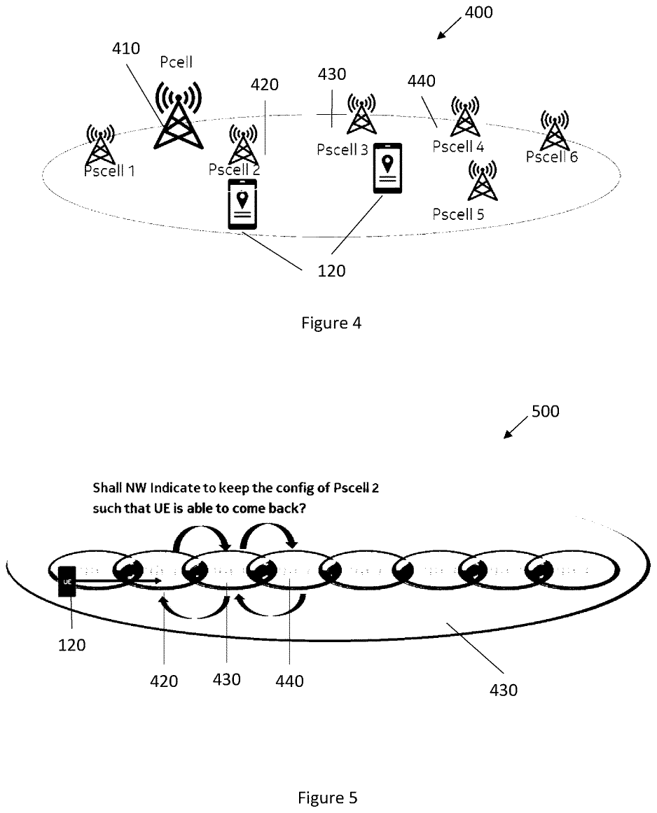

Turning now to FIG. 4, a scenario 400 for selective activation of SCG is illustrated. As illustrated in FIG. 4, user equipment 120 is mobile across a group of PSCells under the overlay coverage of a new radio primary cell 410.

In one or more embodiments, user equipment is served by primary cell 410 and PSCell 420 (Pscell 2). In one or more embodiments, user equipment 120 is configured with CPAC selective activation for target PSCells 430 and 440 (Pscell 3 and Pscell 4). In one or more embodiments, as user equipment moves forwards PSCell 430, the CPC configuration for target PSCell 430 will be executed when the execution condition associated with PSCell 430 is met. In one or more embodiments, after execution, the user equipment 120 keeps the CPC configuration for PSCell 440 in case of subsequent PSCell change. However, in previous embodiments, user equipment 120 does not necessarily keep the CPC configuration for PSCell 430. This can be technically disadvantageous in a situation where there is a subsequent PSCell change away from PSCell 430 and later back to PSCell 430.

Turning now to FIG. 5, a scenario 500 where it is not clear that previous embodiments retain PSCell configuration is illustrated. In this scenario in previous embodiments, user equipment receives CPC configurations for PSCell 420, PSCell 430, and PSCell 440. In one or more previous embodiments, user equipment executes the CPC configuration for PSCell 420, and keeps the CPC configurations for PSCell 430 and PSCell 440. However, user equipment 120 may then release the CPC configuration for PSCell 420. In one or more previous embodiments, if the user equipment 120 leaves and later returns to PSCell 420, then PSCell 420 will need to provide a “self-configuration”, where the self-configuration is the CPC configuration of PSCell 420 that can be used by the user equipment to switch back to a serving PSCell after a PSCell change. In one or more previous embodiments, this unnecessary preparation of the self configuration will be the same as the configuration that the configuration user equipment 120 originally executed for PSCell 420. The lack of retention of this configuration by the user equipment 120 causes unnecessary delay and the preparation of the self-configuration may waste system resources.

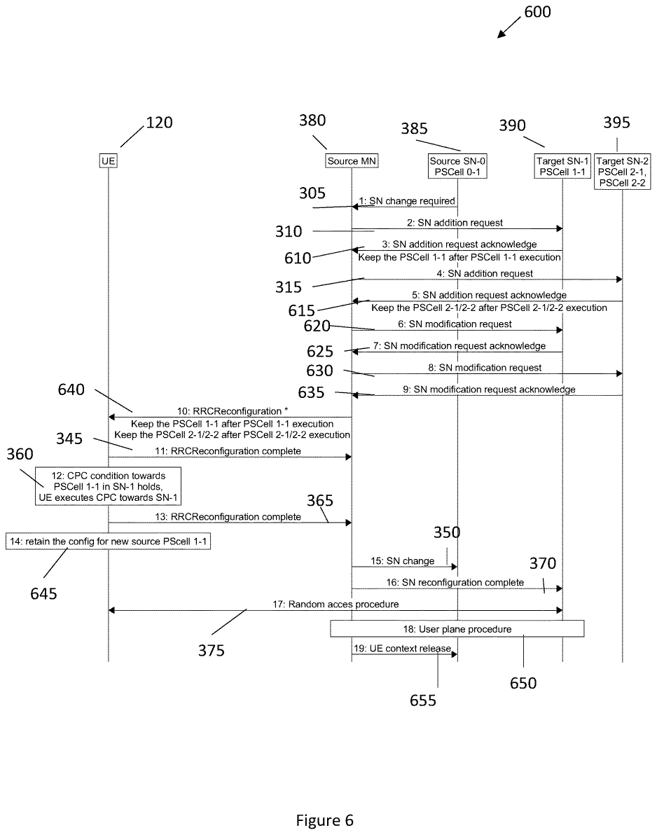

Turning now to FIG. 6, a signaling diagram illustrates a process 600 for source node initiated inter-source node conditional PSCell change (CPC) according to an example embodiment where the executed CPC configuration is retained. In this example embodiment, the user equipment 120 is connected to a source master node 380 and a source secondary node 385, and switches to a PSCell connected to either target secondary node 390 or target secondary node 395. In this example embodiment, user equipment 120 switches to PSCell 1-1 associated with secondary node 390, but in other embodiments, user equipment may switch to PSCell 2-1 or PSCell 2-2 associated with target secondary node 395.

In one or more embodiments, at operation 305, the source secondary node 385 indicates to the master node 380 that there is a source secondary node change required. In one or more embodiments, the source secondary node 385 transmits to the master node 380 a list of IDs of target secondary nodes that will be contacted for preparing target PSCell(s). In one or more embodiments, the source secondary node 385 suggests a list of PSCells to be prepared by the target secondary nodes. In one or more embodiments, the source secondary node provides a CPC execution condition for each suggested target PCell.

In one or more embodiments, at operation 310, the master node 380 transmits an addition request to target secondary node 390. In one or more embodiments, master node 380 transmits the secondary node addition request to target secondary node 390 in response to target secondary node 390 being included in the list of target secondary nodes transmitted in operation 305.

In one or more embodiments, at operation 610, the target secondary node 390 sets a flag indicating to keep the CPC configurations for the prepared target PSCell 1-1 if that configuration is executed. In one or more embodiments, the flag is indicated to the source master node 380 so that the source master node 380 configures the user equipment 120 to store and keep the PCell change configuration to be executed. In one or more embodiments, the target secondary node 390 determines the candidate target PSCell to prepare. In one or more embodiments, the target secondary node 390 determines to prepare PSCell 1-1.

In one or more embodiments, at operation 315, the master node 380 transmits addition requests to target secondary node 395. In one or more embodiments, master node 380 transmits the secondary node addition request to target secondary node 395 in response to target secondary node 395 being included in the list of target secondary nodes transmitted in operation 305.

In one or more embodiments, at operation 615, the target secondary node 395 sets a flag indicating to keep the CPC configurations for the prepared target PSCells 2-1 and 2-2 if one of those configuration is executed. In one or more embodiments, the flag is indicated to the source master node 380 so that the source master node 380 configures the user equipment 120 to store and keep the PCell change configuration(s) to be executed. In one or more embodiments, the target secondary node 390 determines the candidate target PSCells to prepare. In one or more embodiments, the target secondary node 390 determines to prepare PSCell 2-1 and PSCell 2-2.

In one or more embodiments, at operation 620, the source master node 380 transmits a source node modification request to target secondary node 390.

In one or more embodiments, at operation 625, the target secondary node 390 transmits the CPC configuration for the prepared target PSCell 1-1 to the master node 380. In one or more embodiments, at operation 330, the target secondary node 390 transmits the ID of the prepared target PSCell 1-1 to the master node 380.

In one or more embodiments, at operation 630, the source master node 380 transmits a source node modification request to target secondary node 395.

In one or more embodiments, at operation 635, the target secondary node 395 transmits the CPC configuration for each prepared target PSCells 2-1 and 2-2 to the master node 380. In one or more embodiments, at operation 335, the other target secondary nodes 395 transmit the ID of each prepared target PSCell to the master node 380.

In one or more embodiments, at operation 640, the master node 380 transmits a conditional (re)configuration containing the CPC configurations of the candidate target PSCell(s) to the user equipment 120. In one or more embodiments, at operation 640, the master node 380 transmits CPC execution conditions corresponding to the transmitted CPC configurations of the candidate target PSCell(s) to the user equipment 120. In one or more embodiments, the master node 380 transmits the flag to keep a PSCell configuration after execution. In one or more embodiments, the flag is indicated to the user equipment for each configuration provided by master node 380.

In one or more embodiments, at operation 345, the user equipment transmits a confirmation to the master node 380 that the user equipment 120 received the conditional (re)configuration.

In one or more embodiments, at operation 360, a CPC execution condition is met for PSCell 1-1 in secondary node 390. In one or more embodiments, at operation 360, a CPC execution condition is met for PSCell 1-1 in target secondary node 390. In one or more embodiments, the CPC execution condition includes a CP(A)C execution condition. In one or more embodiments, the CPC configuration is executed. In one or more embodiments, user equipment executes the CPC towards secondary node 390 In one or more embodiments, at operation 365, user equipment 120 transmits a message to master node 380 indicating the execution of the CPC configuration. In one or more embodiments, the message includes an embedded secondary node radio resource control reconfiguration complete to the target source node corresponding to the executed CPC configuration. In one or more embodiments, the radio resource control reconfiguration complete is to target source node 390.

In one or more embodiments, at operation 645, the user equipment retains the CPC configuration for new serving cell PSCell 1-1. In one or more embodiments, the configuration is retained as a self-configuration. In one or more embodiments, the configuration is retained as indicated from the radio resource control configuration.

In one or more embodiments, at operation 350, the master node 380 transmits a confirmation to source secondary node 385 that user equipment 120 received the (re)configuration. In one or more embodiments, the master node 380 confirms secondary node change preparation to source secondary node 385. In one or more embodiments, the master node 380 transmits the secondary node radio resource control reconfiguration complete to the source secondary node 385.

In one or more embodiments, at operation 370, the master node 380 transmits the secondary node radio resource control reconfiguration complete to the target secondary node corresponding to the executed CPC configuration. In one or more embodiments, the radio resource control reconfiguration complete is to target secondary node 390. In one or more embodiments, the master node 380 transmits a confirmation to target secondary node 390 that user equipment 120 received the (re)configuration. In one or more embodiments, the master node 380 confirms secondary node change preparation to source secondary node 390.

In one or more embodiments, at operation 375, user equipment 320 completes a random access procedure for target source node 390.

In one or more embodiments, at operation 650, a user plane procedure is completed.

In one or more embodiments, at operation 655, a user equipment context release is delivered from master node 380 to source secondary node 385.

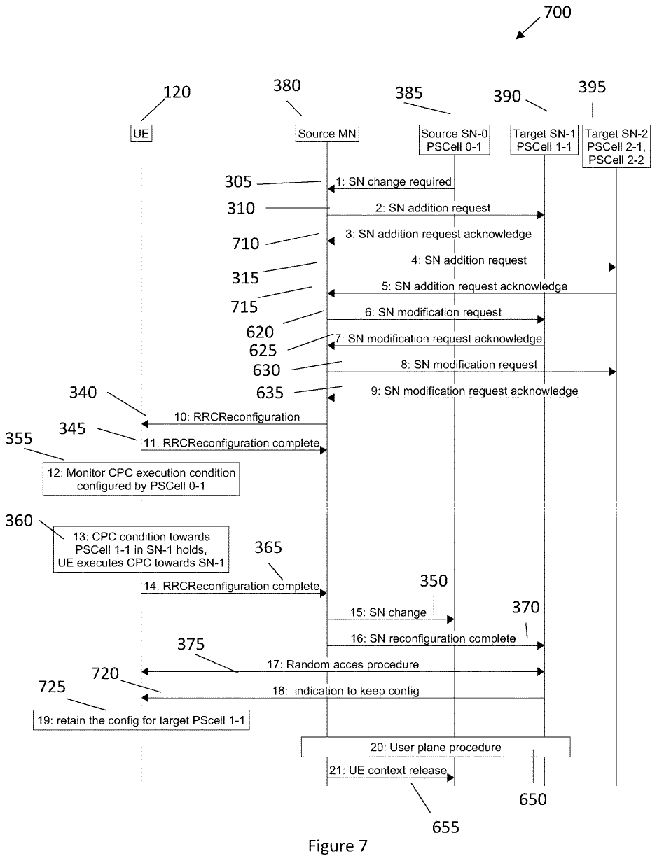

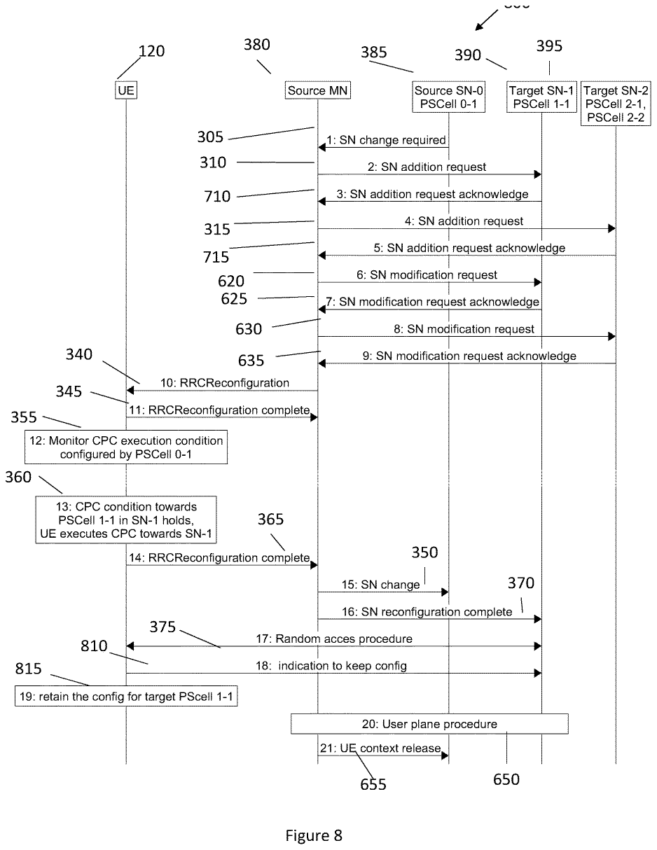

Turning now to FIG. 7, a signaling diagram illustrates an alternative process 700 for source node initiated inter-source node conditional PSCell change (CPC) according to an example embodiment where the executed CPC configuration is retained. In this example embodiment, the user equipment 120 is connected to a source master node 380 and a source secondary node 385, and switches to a PSCell connected to either target secondary node 390 or target secondary node 395. In this example embodiment, user equipment 120 switches to PSCell 1-1 associated with secondary node 390, but in other embodiments, user equipment may switch to PSCell 2-1 or PSCell 2-2 associated with target secondary node 395.

In one or more embodiments, at operation 305, the source secondary node 385 indicates to the master node 380 that there is a source secondary node change required. In one or more embodiments, the source secondary node 385 transmits to the master node 380 a list of IDs of target secondary nodes that will be contacted for preparing target PSCell(s). In one or more embodiments, the source secondary node 385 suggests a list of PSCells to be prepared by the target secondary nodes. In one or more embodiments, the source secondary node provides a CPC execution condition for each suggested target PCell.

In one or more embodiments, at operation 310, the master node 380 transmits an addition request to target secondary node 390. In one or more embodiments, master node 380 transmits the secondary node addition request to target secondary node 390 in response to target secondary node 390 being included in the list of target secondary nodes transmitted in operation 305.

In one or more embodiments, at operation 710, the target secondary node 390 determines the candidate target PSCell to prepare. In one or more embodiments, the target secondary node 390 determines to prepare PSCell 1-1.

In one or more embodiments, at operation 315, the master node 380 transmits addition requests to target secondary node 395. In one or more embodiments, master node 380 transmits the secondary node addition request to target secondary node 395 in response to target secondary node 395 being included in the list of target secondary nodes transmitted in operation 305.

In one or more embodiments, at operation 715, the target secondary node 390 determines the candidate target PSCells to prepare. In one or more embodiments, the target secondary node 390 determines to prepare PSCell 2-1 and PSCell 2-2.

In one or more embodiments, at operation 620, the source master node 380 transmits a source node modification request to target secondary node 390.

In one or more embodiments, at operation 625, the target secondary node 390 transmits the CPC configuration for the prepared target PSCell 1-1 to the master node 380. In one or more embodiments, at operation 330, the target secondary node 390 transmits the ID of the prepared target PSCell 1-1 to the master node 380.

In one or more embodiments, at operation 630, the source master node 380 transmits a source node modification request to target secondary node 395.

In one or more embodiments, at operation 635, the target secondary node 395 transmits the CPC configuration for each prepared target PSCells 2-1 and 2-2 to the master node 380. In one or more embodiments, at operation 335, the other target secondary nodes 395 transmit the ID of each prepared target PSCell to the master node 380.

In one or more embodiments, at operation 340, the master node 380 transmits a conditional (re)configuration containing the CPC configurations of the candidate target PSCell(s) to the user equipment 120. In one or more embodiments, at operation 340, the master node 380 transmits CPC execution conditions corresponding to the transmitted CPC configurations of the candidate target PSCell(s) to the user equipment 120.

In one or more embodiments, at operation 345, the user equipment transmits a confirmation to the master node 380 that the user equipment 120 received the conditional (re)configuration.

In one or more embodiments, at operation 355, user equipment 120 evaluates the CPC execution conditions corresponding to the transmitted CPC configurations of the candidate target PSCell(s). In one or more embodiments, at operation 355, user equipment 120 evaluates the CPC execution conditions of the prepared target PSCell(s).

In one or more embodiments, at operation 360, a CPC execution condition is met for PSCell 1-1 in secondary node 390. In one or more embodiments, at operation 360, a CPC execution condition is met for PSCell 1-1 in target secondary node 390. In one or more embodiments, the CPC execution condition includes a CP(A)C execution condition. In one or more embodiments, the CPC configuration is executed. In one or more embodiments, user equipment executes the CPC towards secondary node 390

In one or more embodiments, at operation 365, user equipment 120 transmits a message to master node 380 indicating the execution of the CPC configuration. In one or more embodiments, the message includes an embedded secondary node radio resource control reconfiguration complete to the target source node corresponding to the executed CPC configuration. In one or more embodiments, the radio resource control reconfiguration complete is to target source node 390.

In one or more embodiments, at operation 350, the master node 380 transmits a confirmation to source secondary node 385 that user equipment 120 received the (re)configuration. In one or more embodiments, the master node 380 confirms secondary node change preparation to source secondary node 385. In one or more embodiments, the master node 380 transmits the secondary node radio resource control reconfiguration complete to the source secondary node 385.

In one or more embodiments, at operation 370, the master node 380 transmits the secondary node radio resource control reconfiguration complete to the target secondary node corresponding to the executed CPC configuration. In one or more embodiments, the radio resource control reconfiguration complete is to target secondary node 390. In one or more embodiments, the master node 380 transmits a confirmation to target secondary node 390 that user equipment 120 received the (re)configuration. In one or more embodiments, the master node 380 confirms secondary node change preparation to source secondary node 390.

In one or more embodiments, at operation 375, user equipment 320 completes a random access procedure for target source node 390.

In one or more embodiments, at operation 720, the target secondary node 390 causes transmission of an indication for the user equipment to retain its own configuration. In one or more embodiments, the indication is sent anytime during the connection. In one or more embodiments, the indication is a radio resource control message. In one or more embodiments, the indication is a MAC control element message. In one or more embodiments, the indication is a downlink control information message.

In one or more embodiments, at operation 725, user equipment retains the configuration for source PSCell 1-1 based at least on the indication from target secondary node 390.

In one or more embodiments, at operation 650, a user plane procedure is completed.

In one or more embodiments, at operation 655, a user equipment context release is delivered from master node 380 to source secondary node 385.

Turning now to FIG. 8, a signaling diagram illustrates an alternative process 800 for source node initiated inter-source node conditional PSCell change (CPC) according to an example embodiment where the executed CPC configuration is retained. In this example embodiment, the user equipment 120 is connected to a source master node 380 and a source secondary node 385, and switches to a PSCell connected to either target secondary node 390 or target secondary node 395. In this example embodiment, user equipment 120 switches to PSCell 1-1 associated with secondary node 390, but in other embodiments, user equipment may switch to PSCell 2-1 or PSCell 2-2 associated with target secondary node 395. In this example embodiment, operations prior to operation 810 are equivalent to those of process 700 depicted in FIG. 7.

In one or more embodiments, at operation 810, the user equipment 120 causes transmission of an indication to retain the executed CPC configuration of the serving PSCEll 1-1 to target secondary node 390. In one or more embodiments, the indication is sent anytime during the connection. In one or more embodiments, the indication is a radio resource control message. In one or more embodiments, the indication is a MAC control element message. In one or more embodiments, the indication is a downlink control information message.

In one or more embodiments, at operation 815, user equipment retains the configuration for source PSCell 1-1 as transmitted in the indication.

In one or more embodiments, at operation 650, a user plane procedure is completed.

In one or more embodiments, at operation 655, a user equipment context release is delivered from master node 380 to source secondary node 385.

In alternative embodiments, user equipment 120 may be configured with a maximum number of configurations. In one or more embodiments, master node 380 may receive an indication from target cells PSCell 1-1, PSCell 2-1, and/or PSCell 2-2 to maintain their configurations. In one or more embodiments, master node 380 may interpret these configurations and send an indication to user equipment 120 which indicates a cell configuration to remove. In one or more embodiments, user equipment 120 may retain all configurations in subsequent CPC other than the one which was indicated not to be maintained by master node 380. In one or more embodiments, user equipment will not perform radio resource control processing on the indicated cell configuration so that a subsequent radio resource control delay is removed.

In one or more of these embodiments, technical advantages are provided. In one or more embodiments, user equipment 120 maintaining the configuration of a serving PSCell reduces T_{RRC_delay} to 0 ms, therefor reducing the time needed to transmit a physical random access channel preamble towards the target PSCell in the future.

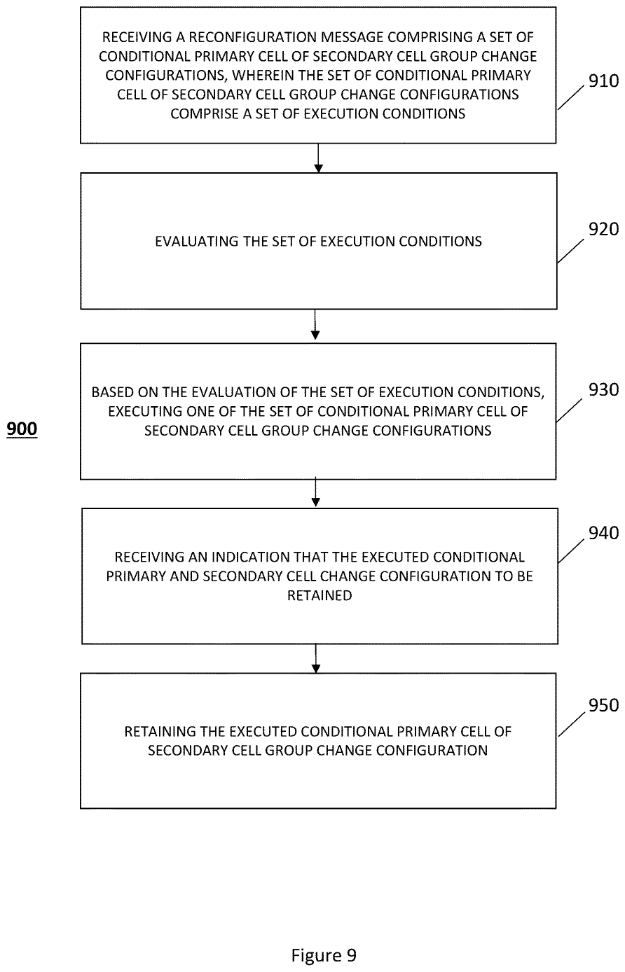

Turning now to FIG. 9, an example flowchart is illustrated for a process 900 performed by an apparatus embodied by, associated with or otherwise in communication with (hereinafter generally referenced as being embodied by) a user equipment 120 to retain an executed conditional primary cell of secondary cell group change configuration.

As shown in block 910 of FIG. 9, the apparatus embodied by the user equipment 120 includes means, such as the processing circuitry 220, the communication interface 260, or the like, for receiving by a user equipment (120) from a master node (380), a reconfiguration message including a set of conditional primary cell of secondary cell group change configurations (CPC config for PSCell 1-1, 2-1 and 2-2 in FIG. 6), wherein the set of conditional primary cell of secondary cell group change configurations include a set of execution conditions. In one or more embodiments, The computer-implemented method of claim 1, wherein the set of conditional primary cell of secondary cell group change configurations includes a plurality of conditional primary cell of secondary cell group change configurations (CPC config for PSCell 1-1, 2-1 and 2-2 in FIG. 6).

As shown in block 920 of FIG. 9, the apparatus embodied by the user equipment 120 includes means, such as the processing circuitry 220, the communication interface 260, or the like, for evaluating the set of execution conditions.

As shown in block 930 of FIG. 9, the apparatus embodied by the user equipment 120 includes means, such as the processing circuitry 220, the communication interface 260, or the like, for, based on the evaluation of the set of execution conditions, executing one of the set of conditional primary cell of secondary cell group change configurations (one of the CPC config for PSCell 1-1, 2-1 and 2-2 in FIG. 6).

As shown in block 940 of FIG. 9, the apparatus embodied by the user equipment 120 includes means, such as the processing circuitry 220, the communication interface 260, or the like, for receiving, from the master node (380), an indication that the executed conditional primary cell of secondary cell group change configuration (CPC config of PSCell 1-1 in FIG. 6) to be retained. In one or more embodiments, the reconfiguration message includes the indication that the executed conditional primary cell of secondary cell group change configuration to be retained (CPC config of PSCell 1-1 in FIG. 6). In one or more embodiments, the indication that the executed conditional primary cell of secondary cell group change configuration to be retained is received from a target secondary node (390) in a second reconfiguration message after execution. In one or more embodiments, the indication includes a radio resource control message. In one or more embodiments, the indication includes a MAC control element message. In one or more embodiments, the indication includes a downlink control information message. In one or more embodiments, wherein the indication that the executed conditional primary cell of secondary cell group change configuration to be retained includes an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained. In one or more embodiments, the reconfiguration message includes the indication that the one or more of the set of conditional primary cell of secondary cell group change configuration not to be retained. In one or more embodiments, the indication that the one or more of the set of conditional primary cell of secondary cell group change configuration not to be retained is received in a second reconfiguration message after execution

As shown in block 950 of FIG. 9, the apparatus embodied by the user equipment 120 includes means, such as the processing circuitry 220, the communication interface 260, or the like, for retaining the executed conditional primary cell of secondary cell group change configuration. In one or more embodiments, the apparatus embodied by the user equipment 120 includes means, such as the processing circuitry 220, the communication interface 260, or the like, for completing a random access procedure associated with the executed conditional primary cell of secondary cell change configuration (CPC config of PSCell 1-1 in FIG. 6).

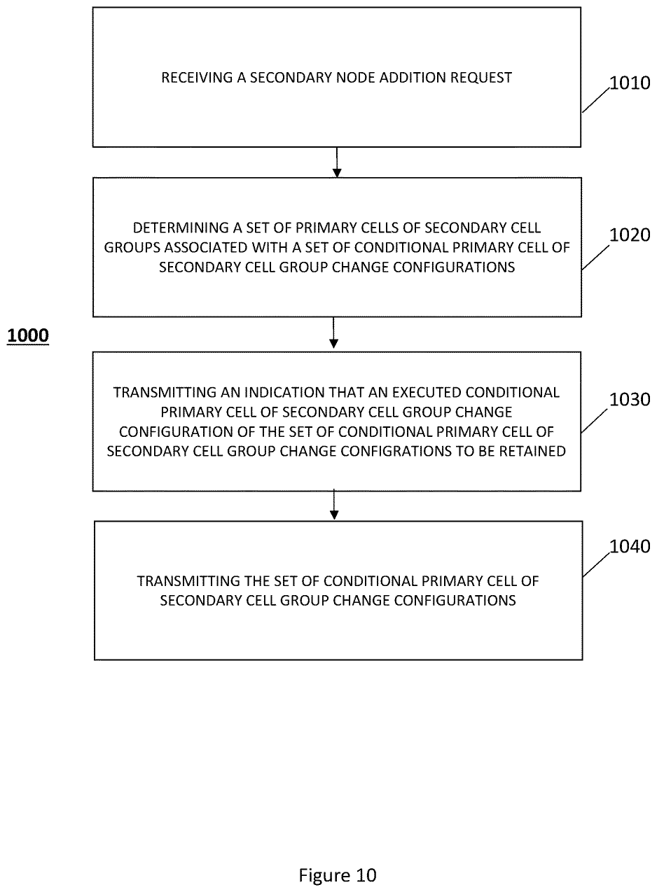

Turning now to FIG. 10, an example flowchart is illustrated for a process 1000 performed by an apparatus embodied by, associated with or otherwise in communication with (hereinafter generally referenced as being embodied by) a base station 140 to cause transmission of a set of conditional primary cell of secondary cell group change configurations. In one or more embodiments, base station 140 includes target secondary node 390. As shown in block 1010 of FIG. 10, the apparatus embodied by the base station 140 includes means, such as the processing circuitry 220, the communication interface 260, or the like, for receiving by a target secondary node (target SN1 390 or target SN2 395), a secondary node addition request from a source master node (380).

As shown in block 1020 of FIG. 10, the apparatus embodied by the base station 140 includes means, such as the processing circuitry 220, the communication interface 260, or the like, for determining a set of primary cells of secondary cell groups (PSCell 1-1 of target SN1 and PSCell 2-1 and 2-2 of target SN2) associated with a set of conditional primary cell of secondary cell group change configurations (CPC config for PSCell 1-1, 2-1 and 2-2 in FIG. 6). In one or more embodiments, the set of conditional primary cell of secondary cell group change configurations includes a plurality of conditional primary cell of secondary cell group change configurations (CPC config for PSCell 1-1, 2-1 and 2-2).

As shown in block 1030 of FIG. 10, the apparatus embodied by the base station 140 includes means, such as the processing circuitry 220, the communication interface 260, or the like, for transmitting an indication that an executed conditional primary cell of secondary cell group change configuration of the set of conditional primary cell of secondary cell group change configurations (CPC config for PSCell 1-1, 2-1 and 2-2) to be retained. In one or more embodiments, wherein the indication that the executed conditional primary cell of secondary cell group change configuration to be retained is transmitted to a source master node (380) prior to the execution of the executed conditional primary cell of secondary cell group change configuration. In one or more embodiments, the indication is transmitted by the source master node (380) to a user equipment (120). In one or more embodiments, the indication that the executed conditional primary cell of secondary cell group change configuration (CPC of PSCell 0-1 in FIG. 6) to be retained is transmitted to a user equipment (120) after executing the executed conditional primary cell of secondary cell group change configuration (CPC of PSCell 0-1 in FIG. 6) and during a connected period. In one or more embodiments, the indication includes a radio resource control message. In one or more embodiments, the indication includes a MAC control element message. In one or more embodiments, the indication includes a downlink control information message.

As shown in block 1040 of FIG. 10, the apparatus embodied by the base station 140 includes means, such as the processing circuitry 220, the communication interface 260, or the like, for transmitting the set of conditional primary cell of secondary cell group change configurations (CPC config for PSCell 1-1, 2-1 and 2-2) to the source master node (380).

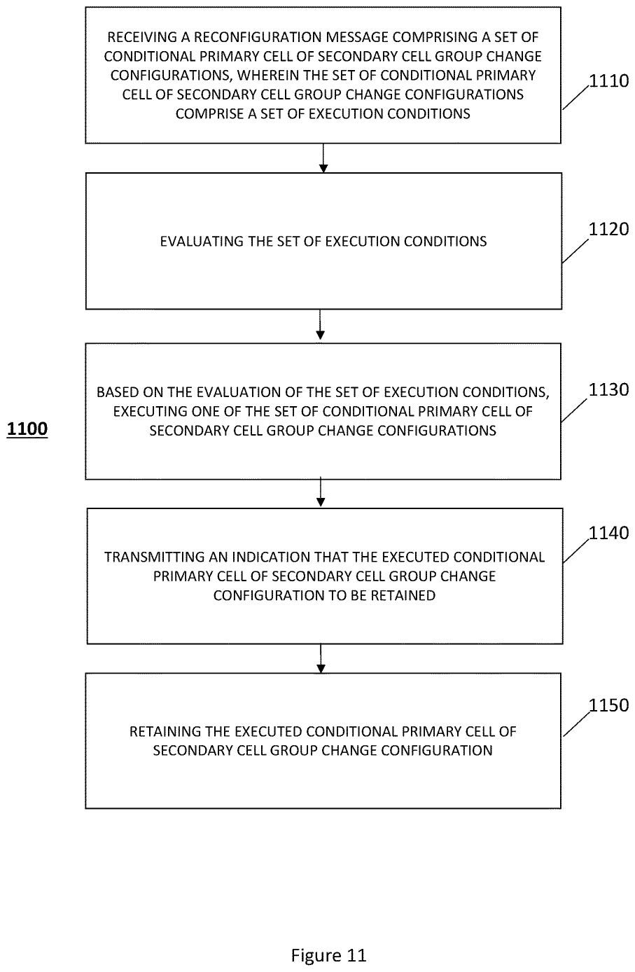

Turning now to FIG. 11, an example flowchart is illustrated for an alternative process 1100 performed by an apparatus embodied by, associated with or otherwise in communication with (hereinafter generally referenced as being embodied by) a user equipment 120 to retain an executed conditional primary cell of secondary cell group change configuration.

As shown in block 1110 of FIG. 11, the apparatus embodied by the user equipment 120 includes means, such as the processing circuitry 220, the communication interface 260, or the like, for receiving by a user equipment (120) from a master node (380), a reconfiguration message including a set of conditional primary cell of secondary cell group change configurations, wherein the set of conditional primary cell of secondary cell group change configurations include a set of execution conditions. In one or more embodiments, the set of conditional primary cell of secondary cell group change configurations include a plurality of conditional primary cell of secondary cell group change configurations.

As shown in block 1120 of FIG. 11, the apparatus embodied by the user equipment 120 includes means, such as the processing circuitry 220, the communication interface 260, or the like, for evaluating the set of execution conditions.

As shown in block 1130 of FIG. 11, the apparatus embodied by the user equipment 120 includes means, such as the processing circuitry 220, the communication interface 260, or the like, for, based on the evaluation of the set of execution conditions, executing one of the set of conditional primary cell of secondary cell group change configurations.

As shown in block 1140 of FIG. 11, the apparatus embodied by the user equipment 120 includes means, such as the processing circuitry 220, the communication interface 260, or the like, for transmitting to another target secondary node (395), an indication that the executed conditional primary cell of secondary cell group change configuration to be retained. In one or more embodiments, the indication that the executed conditional primary cell of secondary cell group change configuration to be retained is transmitted after execution during a connection period. In one or more embodiments, the indication includes a radio resource control message. In one or more embodiments, the indication includes a MAC control element message. In one or more embodiments, the indication includes an uplink control information message.

As shown in block 1150 of FIG. 11, the apparatus embodied by the user equipment 120 includes means, such as the processing circuitry 220, the communication interface 260, or the like, for retaining the executed conditional primary cell of secondary cell group change configuration. In one or more embodiments, the user equipment 120 further includes means, such as the processing circuitry 220, the communication interface 260, or the like, for completing a random access procedure associated with the executed conditional primary cell of secondary cell group change configuration.

FIGS. 9-11 illustrate flowcharts depicting methods according to an example embodiment of the present disclosure. It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 240 of an apparatus employing an embodiment and executed by a processor 220. As will be appreciated, any such computer program instructions may be loaded into a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded into a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments set forth herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-81. (canceled)

82. A user equipment, comprising:
at least one processor; and
at least one memory storing instructions that, when executed by the at least one processor, cause the user equipment to perform:
receive from a master node, a reconfiguration message comprising a set of conditional primary cell of secondary cell group change configurations, wherein the set of conditional primary cell of secondary cell group change configurations comprise a set of execution conditions;
evaluate the set of execution conditions;
based on the evaluation of the set of execution conditions, execute one of the set of conditional primary cell of secondary cell group change configurations;
receive an indication that the executed conditional primary cell of secondary cell group change configuration to be retained; and
retain the executed conditional primary cell of secondary cell group change configuration.

83. The user equipment of claim 82, wherein the reconfiguration message comprises the indication that the executed conditional primary cell of secondary cell group change configuration to be retained.

84. The user equipment of claim 82, wherein the indication that the executed conditional primary cell of secondary cell group change configuration to be retained is received from a secondary node in a second reconfiguration message after execution.

85. The user equipment of claim 82, wherein the set of conditional primary cell of secondary cell group change configurations comprises a plurality of conditional primary cell of secondary cell group change configurations.

86. The user equipment of claim 82, wherein the indication comprises a radio resource control message.

87. The user equipment of claim 82, wherein the indication comprises a MAC control element message.

88. The user equipment of claim 82, wherein the indication comprises a downlink control information message.

89. The user equipment of claim 82, wherein the at least one memory and the computer program code are further configured to, with the at least one processor, cause the user equipment to:
complete a random access procedure associated with the executed conditional primary cell of secondary cell change configuration.

90. The user equipment of claim 82, wherein the indication that the executed conditional primary cell of secondary cell group change configuration to be retained comprises an indication that one or more of the set of conditional primary cell of secondary cell group change configurations not to be retained, and wherein the set of conditional primary cell of secondary cell group change configurations except for the one or more of the set of conditional primary cell of secondary cell group change configurations is retained.

91. The user equipment of claim 90, wherein the reconfiguration message comprises the indication that the one or more of the set of conditional primary cell of secondary cell group change configuration not to be retained.

92. The user equipment of claim 82, wherein the indication that the one or more of the set of conditional primary cell of secondary cell group change configuration not to be retained is received in a second reconfiguration message after execution.

93. A secondary node, comprising:
at least one processor; and
at least one memory storing instructions that, when executed by the at least one processor, cause the secondary node to perform:
receive a secondary node addition request from a source master node;
determine a set of primary cells of secondary cell groups associated with a set of conditional primary cell of secondary cell group change configurations;
transmit an indication that an executed conditional primary cell of secondary cell group change configuration of the set of conditional primary cell of secondary cell group change configurations to be retained; and
transmit the set of conditional primary cell of secondary cell group change configurations to the source master node.

94. The secondary node of claim 93, wherein the indication that the executed conditional primary cell of secondary cell group change configuration to be retained is transmitted to a source master node prior to the execution of the executed conditional primary cell of secondary cell group change configuration.

95. The secondary node of claim 94, wherein the indication is transmitted by the source master node to a user equipment.

96. The secondary node of claim 93, wherein the indication that the executed conditional primary cell of secondary cell group change configuration to be retained is transmitted to a user equipment after executing the executed conditional primary cell of secondary cell group change configuration and during a connected period.

97. The secondary node of claims 93, wherein the set of conditional primary cell of secondary cell group change configurations comprises a plurality of conditional primary cell of secondary cell group change configurations.

98. The secondary node of claim 93, wherein the indication comprises a radio resource control message.

99. The secondary node of claim 93, wherein the indication comprises a MAC control element message.

100. The secondary node of claim 93, wherein the indication comprises a downlink control information message.

101. A user equipment comprising:
at least one processor; and
at least one memory storing instructions that, when executed by the at least one processor, cause the user equipment to perform:
receive from a master node, a reconfiguration message comprising a set of conditional primary cell of secondary cell group change configurations, wherein the set of conditional primary cell of secondary cell group change configurations comprise a set of execution conditions;
evaluate the set of execution conditions;
based on the evaluation of the set of execution conditions, execute one of the set of conditional primary cell of secondary cell group change configurations;
transmit to another secondary node, an indication that the executed conditional primary cell of secondary cell group change configuration to be retained; and
retain the executed conditional primary cell of secondary cell group change configuration.
